(19) United States
(12) Patent Application Publication
(10) Pub. No.: US 2024/0345451 A1
(43) Pub. Date: Oct. 17, 2024

(54) CAMERA MODULE

(71) Applicant: LG INNOTEK CO., LTD., Seoul (KR)

(72) Inventors: Ji Sung KIM, Seoul (KR); Eun Sung SEO, Seoul (KR)

(21) Appl. No.: 18/293,544

(22) PCT Filed: Aug. 8, 2022
(86) PCT No.: PCT/KR2022/011765

§ 371 Date: Jan. 30, 2024

(30) Foreign Application Priority Data
Aug. 9, 2021 (KR) 10-2021-0104663
Aug. 9, 2021 (KR) 10-2021-0104664

(51) Int. Cl. G03B 5/00

(52) U.S. Cl. CPC G03B 5/00; G03B 2205/0023

(57) ABSTRACT

A camera module, according to an embodiment of the present invention, comprises: a first optical unit which changes the path of received light from a first direction to a second direction and outputs the light; a second optical unit which is disposed on an image side of the first optical unit, changes the path of the light received from the first optical unit from the second direction to a third direction, and outputs the light; second lens units which are disposed on the image side of the second optical units and receive the light outputted from the second optical units; and a sensor unit which receives light outputted from the second lens units so as to generate an electrical signal, wherein, in a first OIS mode in which the path of light incident on the sensor unit tilts in the vertical direction with respect to the sensor unit, the first optical unit and the second optical unit rotate with respect to a first rotation axis.

### CROSS-REFERENCE TO RELATED PATENT APPLICATIONS

This application is a U.S. National Stage Application under 35 U.S.C. § 371 of PCT Application No. PCT/KR2022/011765, filed Aug. 8, 2022, which claims priority to Korean Patent Application Nos. 10-2021-0104663 and 10-2021-0104664, both filed Aug. 9, 2021, whose entire disclosures are hereby incorporated by reference.

### TECHNICAL FIELD

Embodiments relate to a camera module.

### BACKGROUND ART

Generally, a camera module receives an optical image of a subject through a lens and captures the optical image of the subject from the image.

Camera modules are applied to portable mobile communication devices, such as camera phones, personal digital assistants (PDAs), and smartphones, and various IT devices.

As users grip these IT devices with their hands to take pictures of the subject, research on optical image stabilization, which compensates for the shaking of the optical image of the subject due to the user's hand shaking, for the camera module is required. The optical image stabilizer (OIS) refers to a method of correcting shaking by mechanically moving a portion of the optical component to change an optical path. Camera modules to which the OIS method is applied implement an OIS function by an actuator for driving the entirety of an auto focusing (AF) module.

However, as the IT devices are becoming lighter and thinner, the size of the camera module should also be reduced, and thus there is an urgent need to develop OIS control technology capable of minimizing an influence on the size of the camera module.

### DISCLOSURE

### Technical Problem

Embodiments are directed to providing a camera module capable of implementing an optical image stabilizer (OIS) function.

The object of embodiments is not limited thereto and may also include objects or effects that may be identified from the configurations or embodiments to be described below.

### Technical Solution

A camera module according to an embodiment of the present invention includes a first optical unit configured to change a path of received light from a first direction to a second direction and output the light, a second optical unit disposed at an image side of the first optical unit and configured to change the path of the light received from the first optical unit from the second direction to a third direction and output the light, a first lens unit disposed at an image side of the second optical unit and configured to receive the light output from the second optical unit, and a sensor unit configured to receive light output from the first lens unit and generate an electrical signal, wherein in a first optical image stabilizer (OIS) mode in which a path of the light incident on the sensor unit is tilted in a vertical direction with respect to the sensor unit, the first optical unit and the second optical unit rotate about a first rotation axis.

The first rotation axis may be an optical axis of the first lens unit.

The first optical unit and the second optical unit may rotate in the same direction in the first OIS mode.

In a second OIS mode in which the path of the light incident on the sensor unit is tilted in a left-right direction with respect to the sensor unit, the first optical unit may rotate about a second rotation axis.

The second rotation axis may be an optical axis between the first optical unit and the second optical unit.

The first optical unit may include a first incident surface on which light is incident, a first reflective surface by which the light incident through the first incident surface is reflected, and a first emitting surface through which the light reflected by the first reflective surface is output, and the second optical unit may include a second incident surface on which light is incident, a second reflective surface by which the light incident through the second incident surface is reflected, and a second emitting surface through which the light reflected by the second reflective surface is output.

The first emitting surface may be disposed parallel to the second incident surface.

The first incident surface may be disposed perpendicular to the second emitting surface.

The camera module may further include a second lens unit disposed at an object side of the first optical unit.

The second lens unit may be formed integrally with the first incident surface or mechanically coupled to the first optical unit to move integrally.

A camera module according to an embodiment of the present invention includes a first lens unit configured to receive light, an optical path-changing unit disposed at an image side of the first lens unit and configured to change a path of the light received through the first lens unit and output the light, and a second lens unit disposed at an image side of the optical path-changing unit and configured to receive the light output from the optical path-changing unit, wherein the first lens unit and the optical path-changing unit rotate at a predetermined angle about a first rotation axis or rotate at a predetermined angles about a second rotation axis.

The first lens unit and the optical path-changing unit may rotate in the same direction.

When the optical path-changing unit rotates at a first rotation angle about the first rotation axis, the first lens unit may rotate at a second rotation angle that differs from the first rotation angle.

The first rotation angle may have a greater value than the second rotation angle.

The first rotation angle may have a value of 1.5 to 2.5 times the second rotation angle.

When rotating about the second rotation axis, the first lens unit and the optical path-changing unit may rotate at the same angle.

The first rotation axis may be perpendicular to the second rotation axis.

The first rotation axis may be perpendicular to an optical axis of the first lens unit and perpendicular to an optical axis of the second lens unit.

The first lens unit may have positive (+) power.

The first lens unit may include at least one lens having a thickness of an edge portion of an effective diameter smaller than a thickness of a central portion of the effective diameter.

The camera module may include a housing, a first holder accommodated inside the housing and coupled to the first lens unit, and a second holder accommodated inside the housing and coupled to the optical path-changing unit.

The first holder may include a first guide groove formed in at least one surface thereof, and the housing may include a first guide groove formed in one surface facing the at least one surface of the first holder in which the first guide groove is disposed.

The first guide groove of the first holder and the first guide groove of the housing may be formed in a circular arc shape and may overlap each other when the first holder is disposed on the housing.

The second holder may include a second guide groove formed in at least one surface thereof, and the housing may include a second guide groove formed in one surface facing the at least one surface of the second holder in which the second guide groove is disposed.

The second guide groove of the second holder and the second guide groove of the housing may be formed in a circular arc shape and may overlap each other when the second holder is disposed on the housing.

### Advantageous Effects

According to embodiments, it is possible to provide an optical image stabilizer (OIS) function to a miniaturized camera module.

In addition, it is possible to provide the OIS function capable of providing high-definition images.

In addition, it is possible to receive the large amount of light when the camera module implements an OIS.

Various and beneficial advantages and effects of the present invention are not limited to the above-described contents and will be more readily understood in a process of describing specific embodiments of the present invention.

### DESCRIPTION OF DRAWINGS

FIG. 1 is a configuration diagram of a camera module according to a first embodiment of the present invention.

FIG. 2 is a perspective view of the camera module according to the first embodiment of the present invention.

FIG. 3 is a plan view of the camera module according to the first embodiment of the present invention.

FIG. 4 is a front view of the camera module according to the first embodiment of the present invention.

FIG. 5 is a side view of the camera module according to the first embodiment of the present invention.

FIG. 6 is a schematic perspective view of the camera module in a first optical image stabilizer (OIS) mode according to the first embodiment of the present invention.

FIG. 7 is a schematic plan view of the camera module in the first OIS mode according to the first embodiment of the present invention.

FIG. 8 is a schematic front view of the camera module in the first OIS mode according to the first embodiment of the present invention.

FIG. 9 is a schematic side view of the camera module in the first OIS mode according to the first embodiment of the present invention.

FIG. 10 is a schematic perspective view of the camera module in a second OIS mode according to the first embodiment of the present invention.

FIG. 11 is a schematic plan view of the camera module in the second OIS mode according to the first embodiment of the present invention.

FIG. 12 is a schematic front view of the camera module in the second OIS mode according to the first embodiment of the present invention.

FIG. 13 is a schematic side view of the camera module in the second OIS mode according to the first embodiment of the present invention.

FIG. 14 is a configuration diagram of a camera module according to a second embodiment of the present invention.

FIGS. 15 and 16 are views of some components of the camera module according to the second embodiment of the present invention viewed from one side.

FIGS. 17 and 18 are views for describing rotation mechanism of a first lens unit and an optical path-changing unit according to the first embodiment of the present invention.

FIGS. 19 and 20 are views for describing a rotational structure of a first lens unit and an optical path-changing unit according to the second embodiment of the present invention.

FIG. 21 is a view illustrating a cross section of a portion of the camera module according to the second embodiment of the present invention.

FIG. 22 is a view illustrating one surface of each of a housing and a holder according to the second embodiment of the present invention.

### MODES OF THE INVENTION

Hereinafter, exemplary embodiments according to the present invention will be described in detail with reference to the accompanying drawings.

However, the technical spirit of the present invention is not limited to some of the described embodiments, but may be implemented in various different forms, and one or more of the components among the embodiments may be used by being selectively coupled or substituted without departing from the scope of the technical spirit of the present invention.

In addition, the terms (including technical and scientific terms) used in embodiments of the present invention may be construed as meaning that may be generally understood by those skilled in the art to which the present invention pertains unless explicitly specifically defined and described, and the meanings of the commonly used terms, such as terms defined in a dictionary, may be construed in consideration of contextual meanings of related technologies.

In addition, the terms used in the embodiments of the present invention are for describing the embodiments and are not intended to limit the present invention.

In the specification, a singular form may include a plural form unless otherwise specified in the phrase, and when described as “at least one (or one or more) of A, B, and C,” one or more among all possible combinations of A, B, and C may be included.

In addition, terms such as first, second, A, B, (a), and (b) may be used to describe components of the embodiments of the present invention.

These terms are only for the purpose of distinguishing one component from another component, and the nature, sequence, order, or the like of the corresponding components is not limited by these terms.

In addition, when a first component is described as being “connected,” “coupled,” or “joined” to a second component, it may include a case in which the first component is directly connected, coupled, or joined to the second component, but also a case in which the first component is “connected,” “coupled,” or “joined” to the second component by other components present between the first component and the second component.

In addition, when a certain component is described as being formed or disposed on “on (above)” or “below (under)” another component, the terms “on (above)” or “below (under)” may include not only a case in which two components are in direct contact with each other, but also a case in which one or more other components are formed or disposed between the two components. In addition, when described as “on (above) or below (under),” it may include the meaning of not only an upward direction but also a downward direction based on one component.

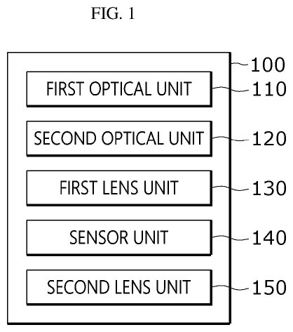

First, a configuration of a camera module according to an embodiment of the present invention will be described with reference to FIGS. 1 to 5.

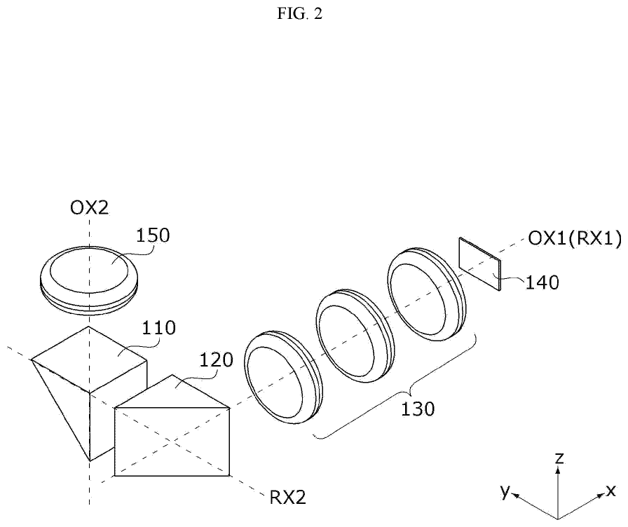

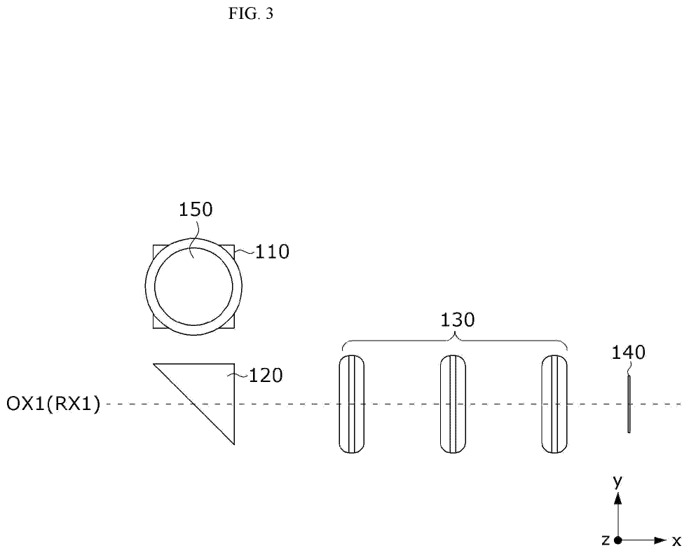

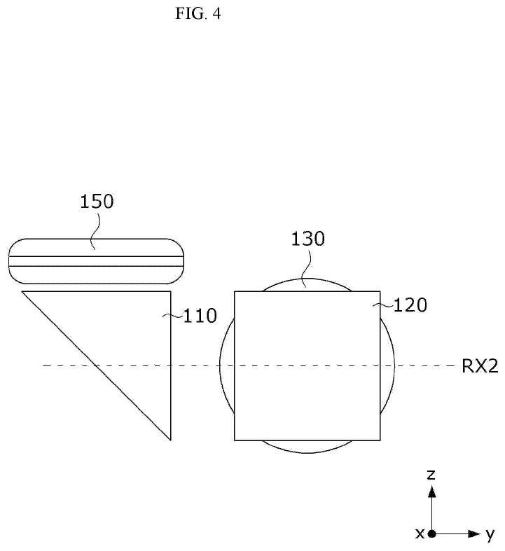

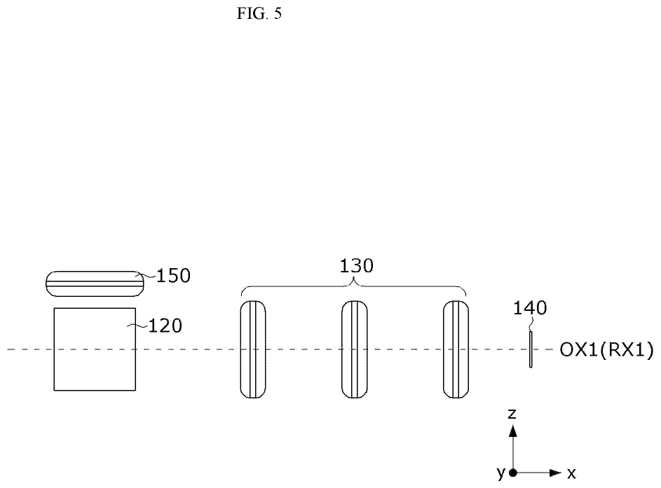

FIG. 1 is a configuration diagram of a camera module according to a first embodiment of the present invention. FIG. 2 is a perspective view of the camera module according to the first embodiment of the present invention. FIG. 3 is a plan view of the camera module according to the first embodiment of the present invention. FIG. 3 is a plan view of the camera module in a z-axis direction. FIG. 4 is a front view of the camera module according to the first embodiment of the present invention. FIG. 4 is a front view of the camera module in an x-axis direction. FIG. 5 is a side view of the camera module according to the first embodiment of the present invention. FIG. 5 is a side view of the camera module in a y-axis direction.

Referring to FIGS. 1 to 5, a camera module 100 according to a first embodiment of the present invention may include a first optical unit 110, a second optical unit 120, a first lens unit 130, and a sensor unit 140 and may further include a second lens unit 150.

The first optical unit 110 may change a path of received light and output the light. The first optical unit 110 may change the path of the received light from a first direction to a second direction and output the light. Here, the first direction may be a direction parallel to a z-axis of the camera module. The second direction may be a direction parallel to a y-axis of the camera module. Therefore, the first direction and the second direction may be directions perpendicular to each other.

When the second lens unit 150 is disposed at a subject side of the first optical unit 110, the first optical unit 110 may change a path of light received through the second lens unit 150 and output the light. The first optical unit 110 may output the light of which the path has been changed toward the second optical unit 120. A second optical axis OX2, which is an optical axis of the second lens unit 150, may be parallel to the z-axis of the camera module. Therefore, the second optical axis OX2 may be parallel to the first direction and perpendicular to the second direction.

According to one embodiment, the first optical unit 110 may be configured as a prism. The first optical unit 110 configured as a prism may include a first surface, a second surface, and a third surface. The first surface of the first optical unit 110 may be a first incident surface. The first incident surface may be a surface that receives light. The second surface of the first optical unit 110 may be a first reflective surface. The first reflective surface may be a surface by which the light incident through the first incident surface is reflected. The third surface of the first optical unit 110 may be a first emitting surface. The first emitting surface may be a surface through which the light reflected by the first reflective surface is output. This can be applied in the same manner even when the first optical unit 110 is configured as a mirror.

The first optical unit 110 may move to implement an optical image stabilizer (OIS) function of the camera module 100. According to one embodiment, the first optical unit 110 may rotate at an arbitrary angle about an arbitrary rotation axis. A path of the reflected light may be changed by rotating the first optical unit 110 at the arbitrary angle. The first optical unit 110 may rotate about different rotation axes in a first OIS mode and a second OIS mode. According to the embodiment, in the first OIS mode in which a path of light incident on the sensor unit 140 is tilted in a vertical direction with respect to the sensor unit 140, the first optical unit 110 may rotate about a first rotation axis RX1 clockwise or counterclockwise. Here, the first rotation axis RX1 may be the same as an optical axis of the first lens unit 130. On the other hand, in the second OIS mode in which the path of the light incident on the sensor unit 140 is tilted in a left-right direction with respect to the sensor unit 140, the first optical unit 110 may rotate about a second rotation axis RX2 clockwise or counterclockwise. Here, the second rotation axis RX2 may be a virtual axis passing through a center of the first optical unit 110 and a center of the second optical unit 120.

In order to implement the OIS function of the first optical unit 110, the camera module 100 may include a first holder and a first actuator. In other words, the camera module 100 may rotate the first optical unit 110 at an arbitrary angle about an arbitrary rotation axis using the first holder and the first actuator. The first holder may be seated in a housing of the camera module 100. The first optical unit 110 may be seated in an internal accommodating space of the first holder. The first optical unit 110 may be accommodated in the internal accommodating space of the first holder. The first holder may be coupled to the first optical unit 110 through a barrel. Therefore, the first optical unit 110 may move according to the movement of the first holder. The first actuator may be seated in the housing of the camera module 100. The first actuator may be accommodated in an internal space of the camera module 100. The first actuator may be coupled to the first holder. The first actuator may provide a driving force so that the first holder rotates about an arbitrary rotation axis. According to one embodiment, the first actuator may be a voice coil motor (VCM) actuator including at least one magnet and at least one coil facing the same. In this case, the coil or magnet may be coupled to the holder, and the facing magnet or coil may be coupled to the housing. In addition, the first actuator may be implemented as an actuator that may provide a driving force to the first holder, such as an encoder actuator or piezo actuator.

The second optical unit 120 may change a path of received light and output the light. The second optical unit 120 may change the path of the received light from the second direction to the third direction and output the light. The second optical unit 120 may be disposed at an image side of the first optical unit 110, and thus change the path of the light received from the first optical unit 110 from the second direction to the third direction and output the light. The second optical unit 120 may output the light of which the path has been changed toward the first lens unit 130.

According to one embodiment, the second optical unit 120 may be configured as a prism. The second optical unit 120 configured as a prism may include a first surface, a second surface, and a third surface. The first surface of the second optical unit 120 may be a second incident surface. The second incident surface may be a surface that receives light. The second surface of the second optical unit 120 may be a second reflective surface. The second reflective surface may be a surface by which the light incident through the second incident surface is reflected. The third surface of the second optical unit 120 may be a second emitting surface. The second emitting surface may be a surface through which the light reflected by the second reflective surface is output. The second incident surface may be disposed to face the first emitting surface. The second incident surface may be disposed parallel to the first emitting surface. The second incident surface may be disposed to face and parallel to the first emitting surface. The second emitting surface may be disposed perpendicular to the first incident surface. This can be applied in the same manner even when the second optical unit 120 is configured as a mirror.

The second optical unit 120 may move to implement the OIS function of the camera module 100. According to one embodiment, the second optical unit 120 may rotate at an arbitrary angle about an arbitrary rotation axis. A path of the reflected light may be changed by rotating the second optical unit 120 at the arbitrary angle. The second optical unit 120 may be driven in different types in the first OIS mode and the second OIS mode. According to the embodiment, in the first OIS mode in which a path of light incident on the sensor unit 140 is tilted in the vertical direction with respect to the sensor unit 140, the second optical unit 120 may rotate about the first rotation axis RX1 clockwise or counterclockwise. In other words, in the first OIS mode, the second optical unit 120 may rotate in the same direction and at the same angle about the same rotation axis like the first optical unit 110. On the other hand, in the second OIS mode in which the path of the light incident on the sensor unit 140 is tilted in the left-right direction with respect to the sensor unit 140, the second optical unit 120 may not rotate. In other words, in the second OIS mode, the second optical unit 120 may not move.

In order to implement the OIS function of the second optical unit 120, the camera module 100 may include a second holder and a second actuator. In other words, the camera module 100 may rotate the second optical unit 120 at an arbitrary angle about an arbitrary rotation axis using the second holder and the second actuator. The second holder may be seated in the housing of the camera module 100. The second optical unit 120 may be seated in an internal accommodating space of the second holder. The second optical unit 120 may be accommodated in the internal accommodating space of the second holder. The second holder may be coupled to the second optical unit 120 through a barrel. Therefore, the second optical unit 120 may move according to the movement of the second holder. The second actuator may be seated in the housing of the camera module 100. The second actuator may be accommodated in the internal space of the camera module 100. The second actuator may be coupled to the second holder. The second actuator may provide a driving force so that the second holder rotates about an arbitrary rotation axis. According to one embodiment, the second actuator may be a VCM actuator including at least one magnet and at least one coil facing the same. In this case, the coil or magnet may be coupled to the holder, and the facing magnet or coil may be coupled to the housing. In addition, the second actuator may be implemented as an actuator that may provide a driving force to the second holder, such as an encoder actuator or piezo actuator.

The first lens unit 130 may be disposed at an image side of the second optical unit 120 and may receive light output from the second optical unit 120. The first lens unit 130 may receive light reflected by the second optical unit 120. The first lens unit 130 may output the received light to the sensor unit 140.

The first lens unit 130 may include a plurality of lenses. The plurality of lenses may form at least one lens group. Therefore, the first lens unit 130 may include at least one lens group. The at least one lens group may provide a zooming function or focusing function to the camera module 100 by moving along the optical axis of the first lens unit 130. For example, the first lens unit 130 may be formed of the first to third lens groups, the first lens group may be fixed, the second lens group may move along the optical axis to provide the zooming function, and the third lens group may move along the optical axis to provide the focusing function.

In order to implement at least one of the zooming and focusing functions of the first lens unit 130, the camera module 100 may include a third holder and a third actuator. In other words, the camera module 100 may perform at least one of the zooming and focusing functions by moving the first lens unit 130 along the optical axis using the third holder and the third actuator.

The third holder may be seated in the housing of the camera module 100. The first lens unit 130 may be seated in an internal accommodating space of the third holder. The first lens unit 130 may be accommodated in the internal accommodating space of the third holder. The third holder may be coupled to the first lens unit 130 through a barrel. Therefore, the first lens unit 130 may move according to the movement of the third holder. When the first lens unit 130 includes at least one lens group, the third holder may be coupled to each of the at least one lens group. The at least one lens group may be coupled to each third holder through each barrel. Therefore, the at least one lens group may independently move according to the movement of the third holder coupled to each lens group.

The third actuator may be seated in the housing of the camera module 100. The third actuator may be accommodated in the internal space of the camera module 100. The third actuator may be coupled to the third holder. The third actuator may provide a driving force so that the third holder moves in an optical axis direction of the second lens group. The third holder moves in the optical axis direction of the second lens group so that the first lens unit 130 moves in the optical axis direction. When the first lens unit 130 includes at least one lens group, the third actuator may be coupled to the third holder to provide an independent driving force to each of the least one lens group. For example, when the first lens unit 130 includes the first to third lens groups and among them, the second lens group and the third lens group move, the third actuator may be coupled to provide an independent driving force to each of the second lens group and the third lens group.

According to one embodiment, the third actuator may be a VCM actuator including at least one magnet and at least one coil facing the same. In this case, the coil or magnet may be coupled to the holder, and the facing magnet or coil may be coupled to the housing. In addition, the third actuator may be implemented as an actuator that may provide a driving force to the third holder, such as an encoder actuator or piezo actuator.

The sensor unit 140 may receive the light output from the first lens unit 130. The sensor unit 140 may convert the received light into an electrical signal and output the electrical signal.

The second lens unit 150 may include at least one lens. According to one embodiment, the second lens unit 150 may be formed of one lens. In another embodiment, the second lens unit 150 may be formed of a plurality of lenses. The second lens unit 150 may have a different number of lenses depending on applications to which the camera module 100 is applied.

The second lens unit 150 may receive light. The second lens unit 150 may receive light incident from a subject. The second lens unit 150 may include at least one light receiving lens. The second lens unit 150 may condense light. The second lens unit 150 may condense light incident from the subject. The second lens unit 150 may include at least one light condensing lens.

The second lens unit 150 may have positive (+) power. When the second lens unit 150 is formed of a lens group including a plurality of lenses, the entirety of the lens group may have the positive (+) power. When the second lens unit 150 is formed of one lens, the one lens may have the positive (+) power.

The second lens unit 150 may include at least one lens having a thickness of an edge portion of an effective diameter smaller than a thickness of a central portion of the effective diameter. When the second lens unit 150 is formed of a lens group including a plurality of lenses, at least one of the plurality of lenses may have the thickness of the edge portion of the effective diameter smaller than the thickness of the central portion of the effective diameter. When the second lens unit 150 is formed of one lens, the one lens may have the thickness of the edge portion of the effective diameter smaller than the thickness of the central portion of the effective diameter.

The second lens unit 150 may include at least one convex lens. When the second lens unit 150 is formed of a lens group including a plurality of lenses, at least one of the plurality of lenses may be a convex lens. When the second lens unit 150 is formed of one lens, the one lens may be a convex lens.

By constituting the second lens unit 150 as described above, the camera module according to the embodiment of the present invention can increase the amount of received light by increasing an F number (Fno).

The second lens unit 150 may be disposed at an object side of the first optical unit 110. According to one embodiment, the second lens unit 150 may be formed integrally with the first incident surface. Therefore, the second lens unit 150 may also rotate integrally when the first optical unit 110 rotates. According to one embodiment, the second lens unit 150 may be mechanically coupled to the first optical unit 110 and formed to move integrally. The second lens unit 150 may be disposed to face and be mechanically coupled to the first incident surface. Therefore, the second lens unit 150 may also rotate integrally when the first optical unit 110 rotates.

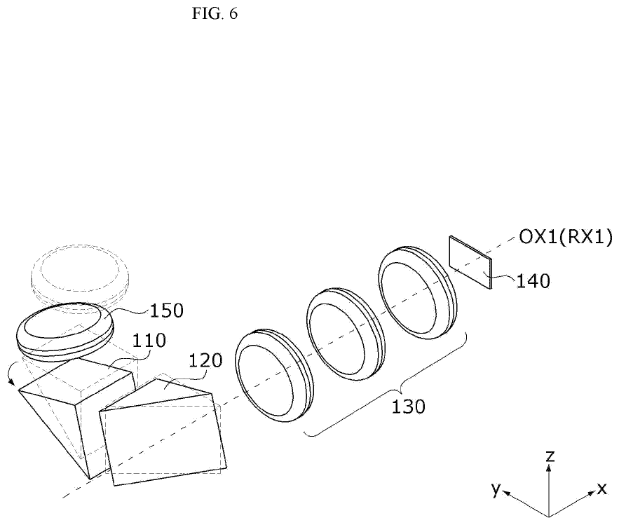

Hereinafter, driving mechanism in the first OIS mode according to the embodiment of the present invention will be described with reference to FIGS. 6 to 9.

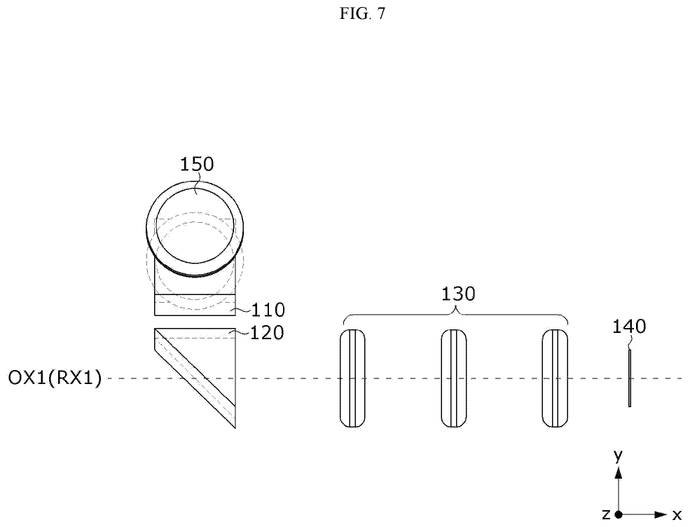

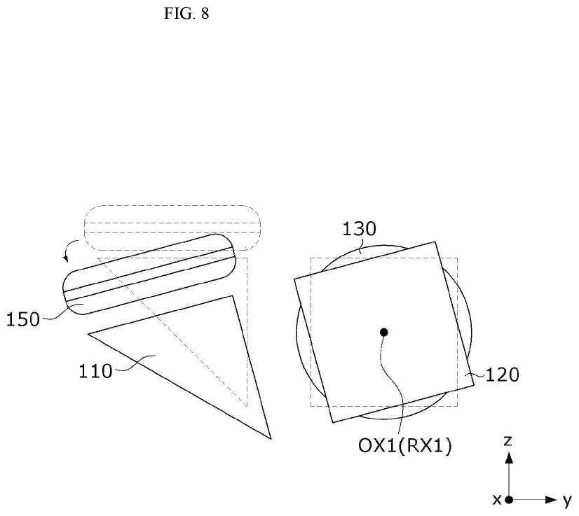

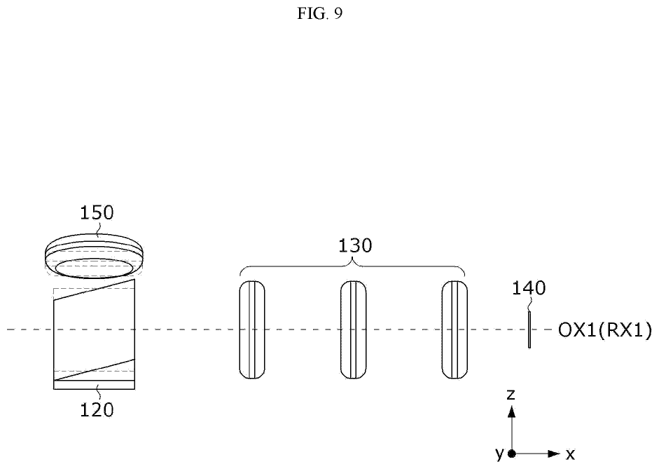

FIG. 6 is a schematic perspective view of the camera module in a first OIS mode according to the first embodiment of the present invention, FIG. 7 is a schematic plan view of the camera module in the first OIS mode according to the first embodiment of the present invention, FIG. 8 is a schematic front view of the camera module in the first OIS mode according to the first embodiment of the present invention, and FIG. 9 is a schematic side view of the camera module in the first OIS mode according to the first embodiment of the present invention.

Referring to FIGS. 6 to 9, in the first OIS mode in which the path of the light incident on the sensor unit 140 is tilted in the vertical direction with respect to the sensor unit 140, the first optical unit 110 and the second optical unit 120 according to the embodiment of the present invention may move in the first OIS mode. In the first OIS mode, the first optical unit 110 and the second optical unit 120 may rotate about the first rotation axis RX1.

According to one embodiment, the first rotation axis RX1 may be the same as the first optical axis OX1, which is the optical axis of the first lens unit 130. The first rotation axis RX1 may be parallel to the x-axis of the camera module 100. The first rotation axis RX1 may be perpendicular to the y-axis of the camera module 100. The first rotation axis RX1 may be perpendicular to the z-axis of the camera module 100.

The first optical unit 110 and the second optical unit 120 may rotate in the same direction in the first OIS mode. For example, in the first OIS mode, when the first optical unit 110 rotates about the first rotation axis RX1 clockwise, the second optical unit 120 may also rotate about the first rotation axis RX1. In the first OIS mode, when the first optical unit 110 rotates about the first rotation axis RX1 counterclockwise, the second optical unit 120 may also rotate about the first rotation axis RX1 counterclockwise.

The first optical unit 110 and the second optical unit 120 may rotate at the same angle in the first OIS mode. For example, in the first OIS mode, when the first optical unit 110 rotates clockwise at 5 degrees about the first rotation axis RX1, the second optical unit 120 may also rotate clockwise at 5 degrees about the first rotation axis RX1. In the first OIS mode, when the first optical unit 110 rotates counterclockwise at 3 degrees about the first rotation axis RX1, the second optical unit 120 may also rotate counterclockwise at 3 degrees about the first rotation axis RX1.

The first optical unit 110 and the second optical unit 120 may rotate integrally in the first OIS mode. For example, in the first OIS mode, when the first optical unit 110 rotates about the first rotation axis RX1 clockwise, the second optical unit 120 may also rotate about the first rotation axis RX1 clockwise. In the first OIS mode, when the first optical unit 110 rotates about the first rotation axis RX1 counterclockwise, the second optical unit 120 may also rotate about the first rotation axis RX1 counterclockwise. To this end, in the first OIS mode, the first optical unit 110 and the second optical unit 120 may be rotated by the same actuator, but are not limited thereto. The first optical unit 110 and the second optical unit 120 may be rotated in the first OIS mode by different actuators.

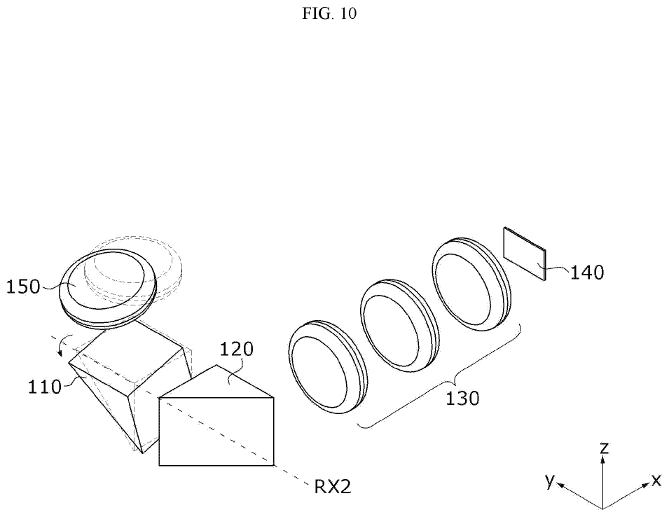

Hereinafter, driving mechanism in the second OIS mode according to the embodiment of the present invention will be described with reference to FIGS. 10 to 13.

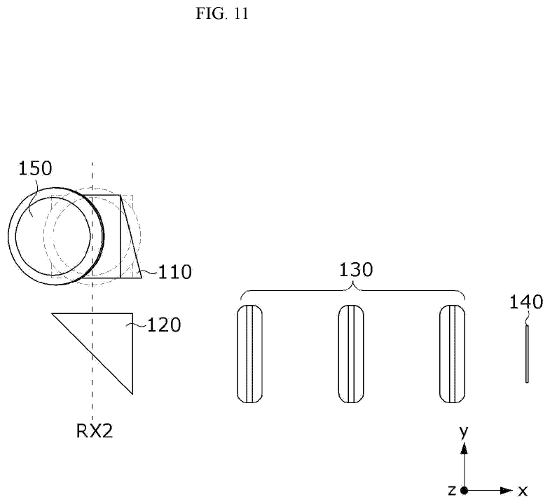

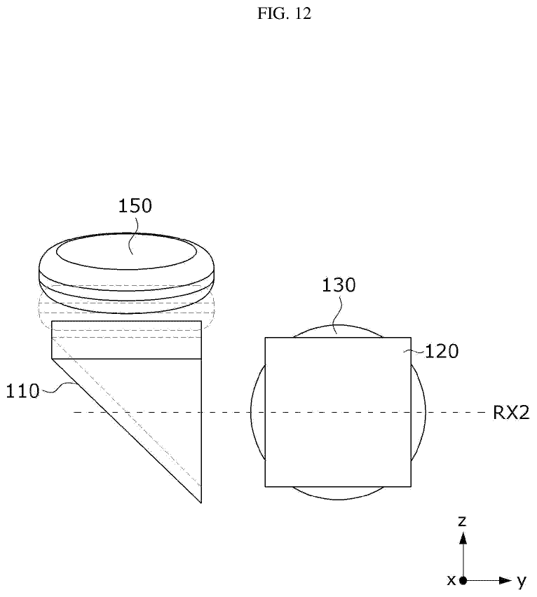

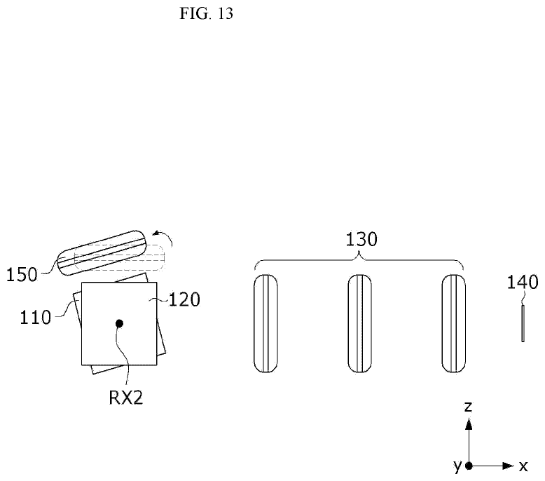

FIG. 10 is a schematic perspective view of the camera module in a second OIS mode according to the first embodiment of the present invention, FIG. 11 is a schematic plan view of the camera module in the second OIS mode according to the first embodiment of the present invention, FIG. 12 is a schematic front view of the camera module in the second OIS mode according to the first embodiment of the present invention, and FIG. 13 is a schematic side view of the camera module in the second OIS mode according to the first embodiment of the present invention.

In the second OIS mode in which the path of the light incident on the sensor unit 140 is tilted in the left-right direction with respect to the sensor unit 140, the first optical unit 110 may rotate about the second rotation axis RX2.

Referring to FIGS. 10 to 13, in the second OIS mode in which the path of the light incident on the sensor unit 140 is tilted in the left-right direction with respect to the sensor unit 140, the first optical unit 110 according to the embodiment of the present invention may move. In the second OIS mode, the first optical unit 110 may rotate about the second rotation axis RX2. At this time, the second optical unit 120 may not move. In other words, only the first optical unit 110 may move in the second OIS mode.

According to one embodiment, the second rotation axis RX2 may be the same as the optical axis between the first optical unit 110 and the second optical unit 120. In other words, the second rotation axis RX2 may be the same as the optical axis connecting the center of the first optical unit 110 to the center of the second optical unit 120 in a state without OIS mode control. The second rotation axis RX2 may be parallel to the y-axis of the camera module 100. The second rotation axis RX2 may be perpendicular to the x-axis of the camera module 100. The second rotation axis RX2 may be perpendicular to the z-axis of the camera module 100.

The first optical unit 110 may rotate in the second OIS mode. For example, in the second OIS mode, the first optical unit 110 may rotate about the second rotation axis RX2 clockwise. At this time, the second optical unit 120 may not rotate. In the second OIS mode, the first optical unit 110 may rotate about the second rotation axis RX2 counterclockwise. At this time, the second optical unit 120 may not rotate. Therefore, in the second OIS mode, light may be tilted and reflected only by the first optical unit 110.

Although the first OIS mode and the second OIS mode have been described above, the camera module according to the embodiment of the present invention may simultaneously operate the first OIS mode and the second OIS mode. Therefore, it is possible to implement the OIS function by tilting in the upward, downward, left, and right directions with respect to the sensor unit 140.

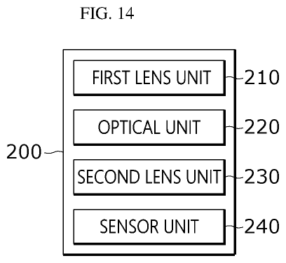

FIG. 14 is a configuration diagram of a camera module according to a second embodiment of the present invention.

Referring to FIG. 14, a camera module 200 according to the second embodiment of the present invention may include a first lens unit 210, an optical path-changing unit 220, a second lens unit 230, a sensor unit 240, and a housing 250.

The first lens unit 210 may include at least one lens. According to one embodiment, the first lens unit 210 may be formed of one lens. In another embodiment, the first lens unit 210 may be formed of a plurality of lenses. The first lens unit 210 may have a different number of lenses depending on applications to which the camera module 200 is applied.

The first lens unit 210 may receive light. The first lens unit 210 may receive light incident from a subject. The first lens unit 210 may include at least one light receiving lens. The first lens unit 210 may condense light. The first lens unit 210 may condense light incident from the subject. The first lens unit 210 may include at least one light condensing lens.

The first lens unit 210 may have positive (+) power. When the first lens unit 210 is formed of a lens group including a plurality of lenses, the entirety of the lens group may have the positive (+) power. When the first lens unit 210 is formed of one lens, the one lens may have the positive (+) power.

The first lens unit 210 may include at least one lens having a thickness of an edge portion of an effective diameter smaller than a thickness of a central portion of the effective diameter. When the first lens unit 210 is formed of a lens group including a plurality of lenses, at least one of the plurality of lenses may have the thickness of the edge portion of the effective diameter smaller than the thickness of the central portion of the effective diameter. When the first lens unit 210 is formed of one lens, the one lens may have the thickness of the edge portion of the effective diameter smaller than the thickness of the central portion of the effective diameter.

The first lens unit 210 may include at least one convex lens. When the first lens unit 210 is formed of a lens group including a plurality of lenses, at least one of the plurality of lenses may be a convex lens. When the first lens unit 210 is formed of one lens, the one lens may be a convex lens.

By constituting the first lens unit 210 as described above, the camera module 200 according to the second embodiment of the present invention can increase the amount of received light by increasing an F number (Fno).

The first lens unit 210 may move to implement the OIS function of the camera module 200. According to one embodiment, the first lens unit 210 may rotate at an arbitrary angle about an arbitrary axis. The path of incident light may be changed by rotating the first lens unit 210 at the arbitrary angle.

In order to implement the OIS function of the first lens unit 210, the camera module 200 may include a first holder and a first actuator. In other words, the camera module 200 may rotate the first lens unit 210 at an arbitrary angle about an arbitrary rotation axis using the first holder and the first actuator.

The first holder may be seated in the housing 250 of the camera module 200. The first lens unit 210 may be seated in an internal accommodating space of the first holder. The first lens unit 210 may be accommodated in the internal accommodating space of the first holder. The first holder may be coupled to the first lens unit 210 through a lens barrel. Therefore, the first lens unit 210 may move according to the movement of the first holder.

The first actuator may be seated in the housing 250 of the camera module 200. The first actuator may be accommodated in an internal space of the camera module 200. The first actuator may be coupled to the first holder. The first actuator may provide a driving force so that the first holder rotates about an arbitrary rotation axis. According to one embodiment, the first actuator may be a VCM actuator including at least one magnet and at least one coil facing the same. In this case, the coil or magnet may be coupled to the holder, and the facing magnet or coil may be coupled to the housing 250. In addition, the first actuator may be implemented as an actuator that may provide a driving force to the first holder, such as an encoder actuator or piezo actuator.

The optical path-changing unit 220 may change the path of the light received through the first lens unit 210 and output the light. The optical path-changing unit 220 may reflect the light incident from the first lens unit 210 and output the light to the second lens unit 230.

The optical path-changing unit 220 may be configured as an optical member capable of reflecting the light incident from the first lens unit 210 and outputting the light to the second lens unit 230. According to one embodiment, the optical path-changing unit 220 may be configured as a prism. The prism may include a first surface on which light is incident from the first lens unit 210, a second surface by which the light incident through the first surface is reflected, and a third surface from which the light reflected by the second surface is output. According to one embodiment, the optical path-changing unit 220 may be configured as a mirror. The mirror may include a reflective surface that reflects the light input from the first lens unit 210. As described above, the optical path-changing unit 220 may reflect the light incident from the outside (e.g., an object) to the inside of the camera module 200. For example, the optical path-changing unit 220 may reflect the incident light toward an image sensor. Therefore, it should be understood that the camera module 200 may provide a high range of magnification by extending the optical path while a thickness thereof is minimized.

The optical path-changing unit 220 may move to implement the OIS function of the camera module 200. According to one embodiment, the optical path-changing unit 220 may rotate at an arbitrary angle about an arbitrary rotation axis. A path of the reflected light may be changed by rotating the optical path-changing unit 220 at the arbitrary angle.

In order to implement the OIS function of the optical path-changing unit 220, the camera module 200 may include a second holder and a second actuator. In other words, the camera module 200 may rotate the optical path-changing unit 220 at an arbitrary angle about an arbitrary rotation axis using the second holder and the second actuator.

The second holder may be seated in the housing 250 of the camera module 200. The optical path-changing unit 220 may be seated in an internal accommodating space of the second holder. The optical path-changing unit 220 may be accommodated in the internal accommodating space of the second holder. The second holder may be coupled to the optical path-changing unit 220 through a lens barrel. Therefore, the optical path-changing unit 220 may move according to the movement of the second holder.

The second actuator may be seated in the housing 250 of the camera module 200. The second actuator may be accommodated in the internal space of the camera module 200. The second actuator may be coupled to the second holder. The second actuator may provide a driving force so that the second holder rotates about an arbitrary rotation axis. According to one embodiment, the second actuator may be a VCM actuator including at least one magnet and at least one coil facing the same. In this case, the coil or magnet may be coupled to the holder, and the facing magnet or coil may be coupled to the housing 250. In addition, the second actuator may be implemented as an actuator that may provide a driving force to the second holder, such as an encoder actuator or piezo actuator.

The second lens unit 230 may receive light emitted from the optical path-changing unit 220. The second lens unit 230 may receive light reflected by the optical path-changing unit 220. The second lens unit 230 may output the received light to the image sensor unit 240.

The second lens unit 230 may include a plurality of lenses. The plurality of lenses may form at least one lens group. Therefore, the second lens unit 230 may include at least one lens group. The at least one lens group may provide a zooming function or focusing function to the camera module 200 by moving along an optical axis of the second lens unit 230. For example, the second lens unit 230 may be formed of the first to third lens groups, the first lens group may be fixed, the second lens group may move along the optical axis to provide the zooming function, and the third lens group may move along the optical axis to provide the focusing function.

In order to implement at least one of the zooming and focusing functions of the second lens unit 230, the camera module 200 may include a third holder and a third actuator. In other words, the camera module 200 may perform at least one of the zooming and focusing functions by moving the second lens unit 230 along the optical axis using the third holder and the third actuator.

The third holder may be seated in the housing 250 of the camera module 200. The second lens unit 230 may be seated in an internal accommodating space of the third holder. The second lens unit 230 may be accommodated in the internal accommodating space of the third holder. The third holder may be coupled to the second lens unit 230 through a lens barrel. Therefore, the second lens unit 230 may move according to the movement of the third holder. When the second lens unit 230 includes at least one lens group, the third holder may be coupled to each of the at least one lens group. The at least one lens group may be coupled to each third holder through each lens barrel. Therefore, the at least one lens group may independently move according to the movement of the third holder coupled to each lens group.

The third actuator may be seated in the housing 250 of the camera module 200. The third actuator may be accommodated in the internal space of the camera module 200. The third actuator may be coupled to the third holder. The third actuator may provide a driving force so that the third holder moves in an optical axis direction of the second lens group. The third holder moves in the optical axis direction of the second lens group so that the second lens unit 230 moves in the optical axis direction. When the second lens unit 230 includes at least one lens group, the third actuator may be coupled to the third holder to provide an independent driving force to each of the least one lens group. For example, when the second lens unit 230 includes the first to third lens groups and among them, the second lens group and the third lens group move, the third actuator may be coupled to provide an independent driving force to each of the second lens group and the third lens group.

According to one embodiment, the third actuator may be a VCM actuator including at least one magnet and at least one coil facing the same. In this case, the coil or magnet may be coupled to the holder, and the facing magnet or coil may be coupled to the housing 250. In addition, the third actuator may be implemented as an actuator that may provide a driving force to the third holder, such as an encoder actuator or piezo actuator.

The image sensor unit 240 may receive light output from the second lens unit 230. The image sensor unit 240 may convert the received light into an electrical signal and output the electrical signal.

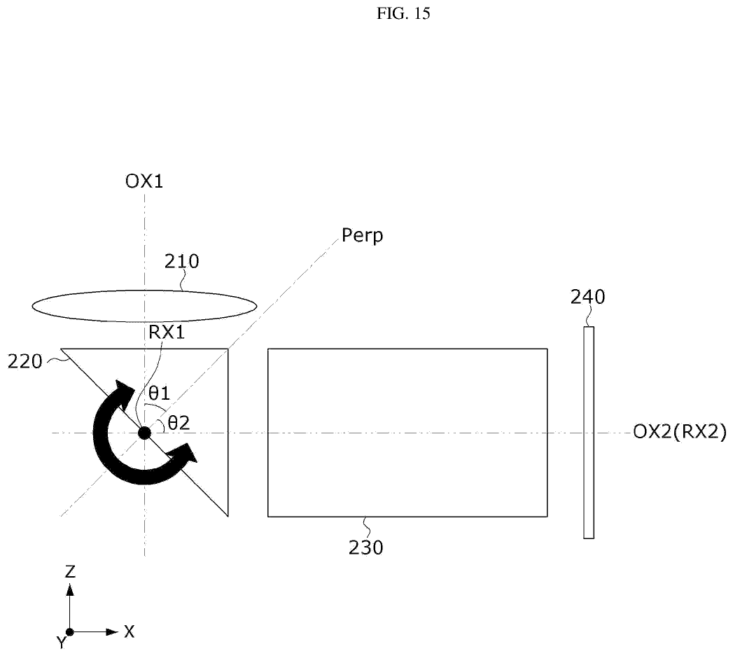

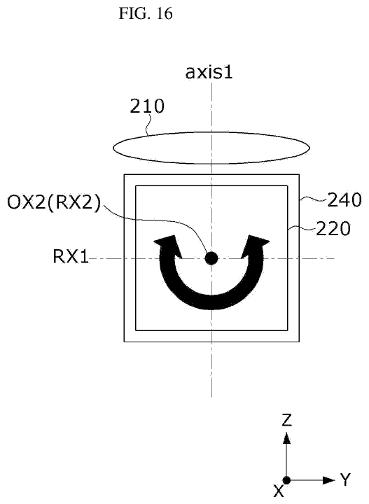

FIGS. 15 and 16 are views of some components of the camera module according to the second embodiment of the present invention viewed from one side.

FIG. 15 is a view illustrating the first lens unit 210, the optical path-changing unit 220, the second lens unit 230, and the sensor unit 240 according to the embodiment of the present invention in the y-axis direction, and FIG. 16 is a view illustrating the first lens unit 210, the optical path-changing unit 220, the second lens unit 230, and the sensor unit 240 according to the embodiment of the present invention in the x-axis direction.

In FIGS. 15 and 16, the x-axis may be an axis that is parallel to a horizontal axis of the camera module 200. The x-axis may be parallel to the optical axis of the second lens unit 230. The x-axis may be perpendicular to a light receiving surface of the sensor unit 240. The y-axis may be parallel to a vertical axis of the camera module 200. The y-axis may be parallel to a horizontal axis of the light receiving surface of the sensor unit 240. The y-axis may be perpendicular to the horizontal axis of the light receiving surface of the sensor unit 240. The y-axis may be perpendicular to the optical axis of the second lens unit 230. The z-axis may be parallel to a height axis of the camera module 200. The z-axis may be perpendicular to the vertical axis of the light receiving surface of the sensor unit 240. The z-axis may be perpendicular to the horizontal axis of the light receiving surface of the sensor unit 240. The z-axis may be perpendicular to the optical axis of the second lens unit 230.

Referring to FIGS. 15 and 16, the first lens unit 210, the optical path-changing unit 220, and the second lens unit 230 may be sequentially disposed from an object side to an image side. Specifically, the first lens unit 210 may be disposed at an object side of the optical path-changing unit 220. The optical path-changing unit 220 may be disposed at an image side of the first lens unit 210. The second lens unit 230 may be disposed at an image side of the optical path-changing unit 220. Therefore, the light incident on the camera module 200 may be input to the sensor unit 240 after sequentially passing through the first lens unit 210, the optical path-changing unit 220, and the second lens unit 230. The light incident through the first lens unit 210 may be reflected by the reflective surface of the optical path-changing unit 220, and the light reflected by the reflective surface may be input to the sensor unit 240 through the second lens unit 230.

According to one embodiment, in a reference state, that is, in a state in which the first lens unit 210 and the optical path-changing unit 220 do not move, the first optical axis OX1 of the first lens unit 210 and the second optical axis OX2 of the second lens unit 230 may be perpendicular to each other. An intersection at which the first optical axis OX1 and the second optical axis OX2 intersect may be formed on a reflective surface of the optical path-changing unit 220. An angle (i.e., an angle of incidence θ1) formed by a perpendicular line Perp of the reflective surface passing through the intersection and the first optical axis OX1 may be the same as an angle (i.e., a reflective angle θ2) formed by the perpendicular line Perp and the second rotation axis RX2. Therefore, the light incident through the first lens unit 210 along the first optical axis OX1 may be reflected by the reflective surface of the optical path-changing unit 220 and output to the second lens unit 230 along the second optical axis OX2.

The first lens unit 210 and the optical path-changing unit 220 may rotate about the rotation axes. The first lens unit 210 and the optical path-changing unit 220 may rotate at a predetermined angle about the first rotation axis RX1 or rotate at a predetermined angle about the second rotation axis RX2. The first lens unit 210 and the optical path-changing unit 220 can implement the OIS function by rotating about the first rotation axis RX1 or the second rotation axis RX2, which is a rotation axis. In other words, the rotation axis may be at least one of the first rotation axis RX1 or the second rotation axis RX2.

According to one embodiment, the first lens unit 210 and the optical path-changing unit 220 may rotate at the predetermined angle about the first rotation axis RX1. In other words, the first lens unit 210 and the optical path-changing unit 220 may rotate clockwise or counterclockwise using the first rotation axis RX1 as a rotation axis. Here, the first rotation axis RX1 may be an axis perpendicular to the first optical axis OX1 and the second optical axis OX2. The first rotation axis RX1 may be an axis that passes through the intersection of the first optical axis OX1 and the second optical axis OX2 and is perpendicular to the first optical axis OX1 and the second optical axis OX2. The first rotation axis RX1 may be an axis that passes through the intersection of the first optical axis OX1 and the second optical axis OX2 and is parallel to the y-axis. The first rotation axis RX1 may be an axis that passes through the intersection of the first optical axis OX1 and the second optical axis OX2 and is perpendicular to the x-axis and z-axis. The first rotation axis RX1 may be perpendicular to the second rotation axis RX2.

According to another embodiment, the first lens unit 210 and the optical path-changing unit 220 may rotate at a predetermined angle about the second rotation axis RX2. In other words, the first lens unit 210 and the optical path-changing unit 220 may rotate clockwise or counterclockwise using the second rotation axis RX2 as a rotation axis. Here, the second rotation axis RX2 may be an axis perpendicular to the first optical axis OX1 and the first rotation axis RX1. The second rotation axis RX2 may be an axis that passes through the intersection of the first optical axis OX1 and the second optical axis OX2 and is perpendicular to the first optical axis OX1 and the first rotation axis RX1. The second rotation axis RX2 may be an axis that passes through the intersection of the first optical axis OX1 and the second optical axis OX2 and is parallel to the x-axis. The second rotation axis RX2 may be an axis that passes through the intersection of the first optical axis OX1 and the second optical axis OX2 and is perpendicular to the y-axis and z-axis. The second rotation axis RX2 may be perpendicular to the first rotation axis RX1. The second rotation axis RX2 may be the second optical axis OX2.

The first lens unit 210 and the optical path-changing unit 220 may rotate in the same direction. According to one embodiment, when the optical path-changing unit 220 rotates clockwise using the first rotation axis RX1 as a rotation axis, the first lens unit 210 may rotate clockwise using the first rotation axis RX1 as a rotation axis. According to one embodiment, when the optical path-changing unit 220 rotates counterclockwise using the first rotation axis RX1 as a rotation axis, the first lens unit 210 may rotate counterclockwise using the first rotation axis RX1 as a rotation axis. According to one embodiment, when the optical path-changing unit 220 rotates clockwise using the second rotation axis RX2 as a rotation axis, the first lens unit 210 may rotate clockwise using the second rotation axis RX2 as a rotation axis. According to one embodiment, when the optical path-changing unit 220 rotates counterclockwise using the second rotation axis RX2 as a rotation axis, the first lens unit 210 may rotate counterclockwise using the second rotation axis RX2 as a rotation axis.

The rotation angles of the first lens unit 210 and the optical path-changing unit 220 may differ from or the same as each other depending on about which rotation axis they rotate. According to one embodiment, when the first lens unit 210 and the optical path-changing unit 220 rotate clockwise or counterclockwise using the first rotation axis RX1 as a rotation axis, the first lens unit 210 and the optical path-changing unit 220 may rotate at different rotation angles. According to one embodiment, when the first lens unit 210 and the optical path-changing unit 220 rotate clockwise or counterclockwise using the second rotation axis RX2 as a rotation axis, the first lens unit 210 and the optical path-changing unit 220 may rotate at the same rotation angle.

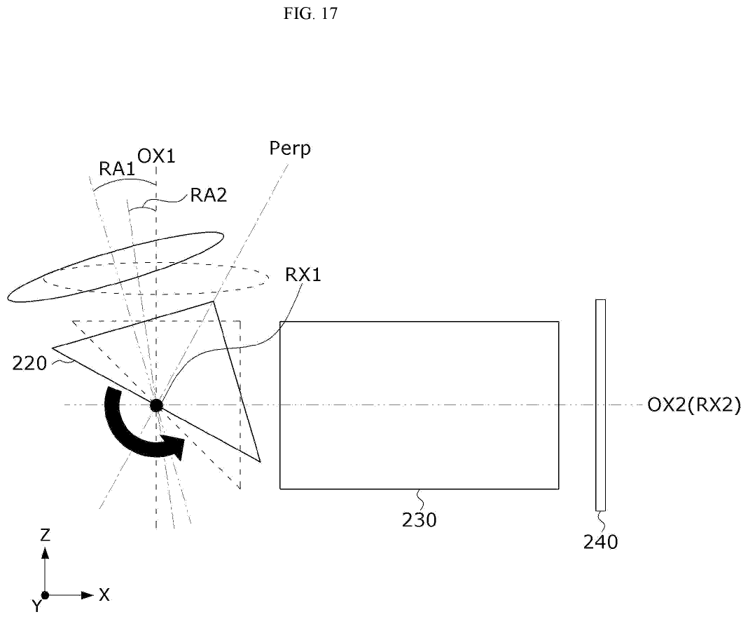

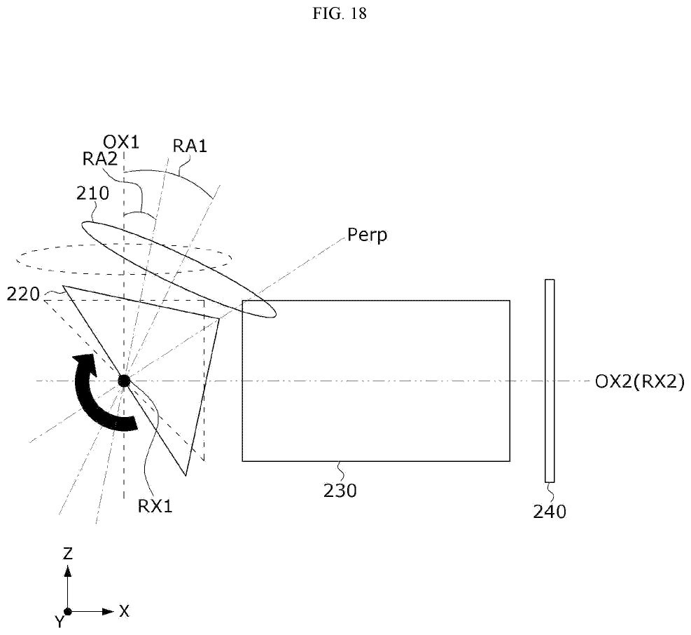

FIGS. 17 and 18 are views for describing rotation mechanism of a first lens unit and an optical path-changing unit according to the first embodiment of the present invention.

According to the embodiment of the present invention, when the first lens unit 210 and the optical path-changing unit 220 rotate using the first rotation axis RX1 as a rotation axis, the first lens unit 210 and the optical path-changing unit 220 may rotate at different rotation angles. A first rotation angle RA1 at which the first lens unit 210 rotates about the first rotation axis RX1 may differ from a second rotation angle RA2 at which the optical path-changing unit 220 rotates about the first rotation axis RX1. The first rotation angle RA1 at which the first lens unit 210 rotates about the first rotation axis RX1 may be greater than the second rotation angle RA2 at which the optical path-changing unit 220 rotates about the first rotation axis RX1. According to one embodiment, the first rotation angle RA1 may be twice the second rotation angle RA2. In this case, since there may be errors occurring in a process of implementing the rotation of the first lens unit 210 and the optical path-changing unit 220, the first rotation angle RA1 may not be exactly twice the second rotation angle RA2 and may have an error value. Considering this error, according to one embodiment, the first rotation angle RA1 may have a value between 1.5 and 2.5 times the second rotation angle RA2. According to one embodiment, the first rotation angle RA1 may have a value between 1.8 and 2.2 times the second rotation angle RA2. According to one embodiment, the first rotation angle RA1 may have a value between 1.9 and 2.1 times the second rotation angle RA2. According to one embodiment, the first rotation angle RA1 may have a value between 1.95 and 2.05 times the second rotation angle RA2.

Referring to FIG. 17, the first lens unit 210 and the optical path-changing unit 220 may rotate counterclockwise using the first rotation axis RX1 as a rotation axis. The first lens unit 210 may rotate counterclockwise at the first rotation angle RA1 using the first rotation axis RX1 as a rotation axis. In addition, the optical path-changing unit 220 may rotate counterclockwise at the second rotation angle RA2 using the first rotation axis RX1 as a rotation axis. As the optical path-changing unit 220 rotates using the first rotation axis RX1 as a rotation axis, the reflective surface of the optical path-changing unit 220 may be tilted. The reflective surface of the optical path-changing unit 220 may be tilted in a vertical direction of the sensor unit 240 at the second rotation angle RA2. The light incident along the optical axis of the optical path-changing unit 220 may be incident on the reflective surface of the optical path-changing unit 220 tilted in the vertical direction of the sensor unit 240 at the second rotation angle RA2. In addition, light reflected by the tilted reflective surface may be output toward the second lens unit 230, may pass through the second lens unit 230, and may be input to the sensor unit 240.

Referring to FIG. 18, the first lens unit 210 and the optical path-changing unit 220 may rotate clockwise using the first rotation axis RX1 as a rotation axis. The first lens unit 210 may rotate clockwise at the first rotation angle RA1 using the first rotation axis RX1 as a rotation axis. In addition, the optical path-changing unit 220 may rotate clockwise at the second rotation angle RA2 using the first rotation axis RX1 as a rotation axis. As the optical path-changing unit 220 rotates using the first rotation axis RX1 as a rotation axis, the reflective surface of the optical path-changing unit 220 may be tilted. The reflective surface of the optical path-changing unit 220 may be tilted in a vertical direction of the sensor unit 240 at the second rotation angle RA2. The light incident along the optical axis of the optical path-changing unit 220 may be incident on the reflective surface of the optical path-changing unit 220 tilted in the vertical direction of the sensor unit 240 at the second rotation angle RA2. In addition, light reflected by the tilted reflective surface may be output toward the second lens unit 230, may pass through the second lens unit 230, and may be input to the sensor unit 240.

When the first lens unit 210 and the optical path-changing unit 220 rotate using the first rotation axis RX1 as a rotation axis, the first rotation angle RA1 may be twice the second rotation angle RA2. As the first rotation angle RA1 becomes twice the second rotation angle RA2, the angle formed by the perpendicular line Perp of the reflective surface moved by the rotation of the optical path-changing unit 220 and the first optical axis OX1 may become the same as the angle formed by the perpendicular line Perp of the reflective surface moved by the rotation of the optical path-changing unit 220 and the second optical axis OX2. In other words, a path of the first optical axis OX1 reflected by the reflective surface and the second optical axis OX2 of the second lens unit 230 may match. Therefore, it is possible to not only increase the amount of the light received by the first lens unit 210, but also acquire a clear image when the OIS function of the camera module 200 is driven. When the first rotation angle RA1 is not twice the second rotation angle RA2, the path of the first optical axis OX1 reflected by the reflective surface and the second optical axis OX2 of the second lens unit 230 do not match. In this case, the amount of the light received can be increased by the first lens unit 210, but a problem that the clarity of the acquired image is degraded occurs.

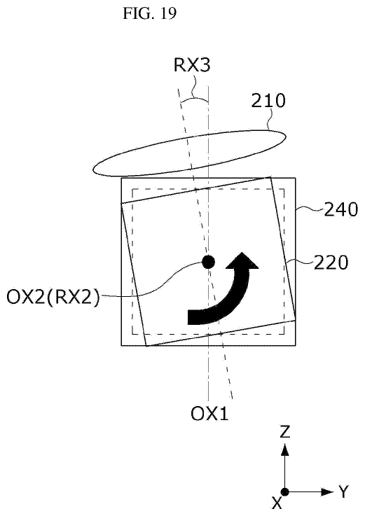

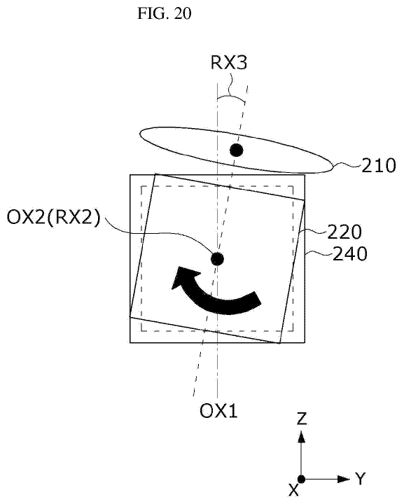

FIGS. 19 and 20 are views for describing a rotational structure of a first lens unit and an optical path-changing unit according to the second embodiment of the present invention.

According to the embodiment of the present invention, when the first lens unit 210 and the optical path-changing unit 220 rotate using the second rotation axis RX2 as a rotation axis, the first lens unit 210 and the optical path-changing unit 220 may rotate at the same rotation angle. When the first lens unit 210 rotates about the second rotation axis RX2 at a third rotation angle RA3, the optical path-changing unit 220 may also rotate about the second rotation axis RX2 at the third rotation angle RA3. In this case, since there may be errors occurring in the process of implementing the rotation of the first lens unit 210 and the optical path-changing unit 220, the third rotation angle RA3 at which the first lens unit 210 rotates and the third rotation angle RA3 at which the optical path-changing unit 220 rotates may not exactly match and may have an error value.

Referring to FIG. 19, the first lens unit 210 and the optical path-changing unit 220 may rotate counterclockwise using the second rotation axis RX2 as a rotation axis. The first lens unit 210 may rotate counterclockwise at the third rotation angle RA3 using the second rotation axis RX2 as a rotation axis. In addition, the optical path-changing unit 220 may rotate counterclockwise at the third rotation angle RA3 using the second rotation axis RX2 as a rotation axis. As the optical path-changing unit 220 rotates using the first rotation axis RX1 as a rotation axis, the reflective surface of the optical path-changing unit 220 may be tilted. The reflective surface of the optical path-changing unit 220 may be tilted in a left-right direction of the sensor unit 240 at the third rotation angle RA3. The light incident along the optical axis of the optical path-changing unit 220 may be incident on the reflective surface of the optical path-changing unit 220 tilted in the left-right direction of the sensor unit 240 at the third rotation angle RA3. In addition, light reflected by the tilted reflective surface may be output toward the second lens unit 230, may pass through the second lens unit 230, and may be input to the sensor unit 240.

Referring to FIG. 20, the first lens unit 210 and the optical path-changing unit 220 may rotate clockwise using the second rotation axis RX2 as a rotation axis. The first lens unit 210 may rotate clockwise at the third rotation angle RA3 using the second rotation axis RX2 as a rotation axis. In addition, the optical path-changing unit 220 may rotate clockwise at the third rotation angle RA3 using the second rotation axis RX2 as a rotation axis. As the optical path-changing unit 220 rotates using the second rotation axis RX2 as a rotation axis, the reflective surface of the optical path-changing unit 220 may be tilted. The reflective surface of the optical path-changing unit 220 may be tilted in a left-right direction of the sensor unit 240 at the third rotation angle RA3. The light incident along the optical axis of the optical path-changing unit 220 may be incident on the reflective surface of the optical path-changing unit 220 tilted in the left-right direction of the sensor unit 240 at the third rotation angle RA3. In addition, light reflected by the tilted reflective surface may be output toward the second lens unit 230, may pass through the second lens unit 230, and may be input to the sensor unit 240.

As the first lens unit 210 and the optical path-changing unit 220 rotate at the third rotation angle RA3, the angle formed by the perpendicular line Perp of the reflective surface moved by the rotation of the optical path-changing unit 220 and the first optical axis OX1 may become the same as the angle formed by the perpendicular line Perp of the reflective surface moved by the rotation of the optical path-changing unit 220 and the second optical axis OX2. In other words, a path of the first optical axis OX1 reflected by the reflective surface and the second optical axis OX2 of the second lens unit 230 may match. Therefore, it is possible to not only increase the amount of the light received by the first lens unit 210, but also acquire a clear image when the OIS function of the camera module 200 is driven. When the rotating angles of the first lens unit 210 and the optical path-changing unit 220 are not the same, the path of the first optical axis OX1 reflected by the reflective surface and the second optical axis OX2 of the second lens unit 230 do not match. In this case, the amount of the light received can be increased by the first lens unit 210, but a problem that the clarity of the acquired image is degraded occurs.

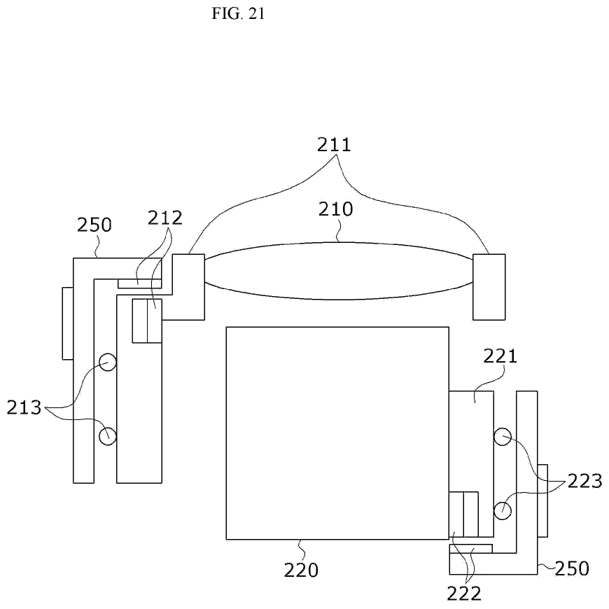

FIG. 21 is a view illustrating a cross section of a portion of the camera module according to the second embodiment of the present invention.

Referring to FIG. 21, the camera module 200 according to the second embodiment of the present invention may include the housing 250, the first lens unit 210, a first holder 211, a first actuator 212, and a first ball 213. In addition, the camera module 200 according to the embodiment of the present invention may include the optical path-changing unit 220, a second holder 221, a second actuator 222, and a second ball 223.

The housing 250 may accommodate the first lens unit 210, the first holder 211, the first actuator 212, and the first ball 213. The housing 250 may accommodate the second lens unit 230, the second holder 221, the second actuator 222, and the second ball 223.

The first lens unit 210 may be accommodated in the first holder 211. According to one embodiment, the first lens unit 210 may be coupled to the first holder 211 through a lens barrel.

The first holder 211 may be accommodated in the housing 250. The first holder 211 may accommodate the first lens unit 210. The first holder 211 may be coupled to the first lens unit 210.

The first actuator 212 may include a first coil and a first magnet facing the same. The first coil may be coupled to the housing 250. The first coil may be disposed on an inner surface of the housing 250. The first magnet may be coupled to the first holder 211. The first magnet may be coupled to the first holder 211 to face the first coil. The first actuator 212 may provide a driving force to the first holder 211 by a Lorentz force between the first coil and the first magnet. Here, although it is described that the first coil is coupled to the housing 250 and the first magnet is coupled to the first holder 211, the first coil may be coupled to the first holder 211, and the first magnet may be coupled to the housing 250.

The first ball 213 may be disposed between the housing 250 and the first holder 211. A plurality of first balls 213 may be provided.

The optical path-changing unit 220 may be accommodated in the second holder 221. According to one embodiment, the optical path-changing unit 220 may be coupled to the second holder 221 through a lens barrel.

The second holder 221 may be accommodated in the housing 250. The second holder 221 may accommodate the optical path-changing unit 220. The second holder 221 may be coupled to the optical path-changing unit 220.

The second actuator 222 may include a second coil and a second magnet facing the same. The second coil may be coupled to the housing 250. The second coil may be disposed on the inner surface of the housing 250. The second magnet may be coupled to the second holder 221. The second magnet may be coupled to the second holder 221 to face the second coil. The second actuator 222 may provide a driving force to the second holder 221 by a Lorentz force between the second coil and the second magnet. Here, although it is described that the second coil is coupled to the housing 250 and the second magnet is coupled to the second holder 221, the second coil may be coupled to the second holder 221, and the second magnet may be coupled to the housing 250.

The second ball 223 may be disposed between the housing 250 and the second holder 221. A plurality of second balls 223 may be provided.

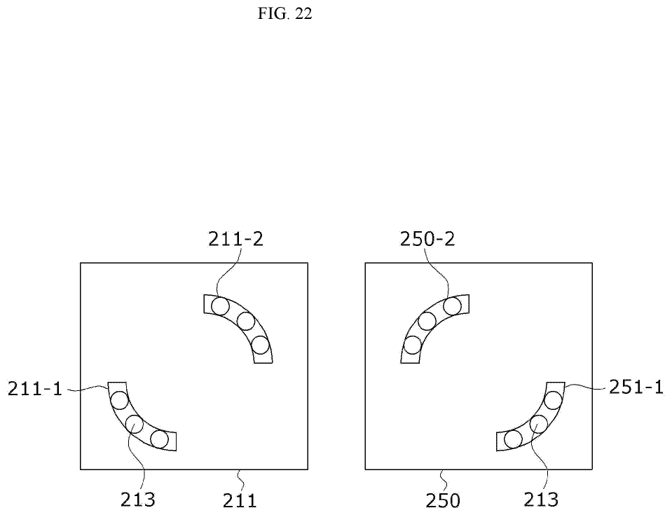

FIG. 22 is a view illustrating one surface of each of a housing and a holder according to the embodiment of the present invention.

According to the embodiment of the present invention, the housing 250 and the holder may each include a guide groove. A ball may be disposed in the guide groove.

Specifically, the housing 250 may include a first guide groove. The first guide groove may be formed in one surface of the housing 250. In addition, the first holder 211 may include the first guide groove. The first guide groove may be formed in one surface of the first holder 211. The one surface of the housing 250 in which the first guide groove is formed and the one surface of the first holder 211 in which the first guide groove is formed may be facing surfaces. Therefore, when the first holder 211 is accommodated in the housing 250, the first guide groove of the housing 250 may overlap the first guide groove of the first holder 211. A first ball 213 may be disposed between the first guide groove of the housing 250 and the first guide groove of the first holder 211. The first guide groove may be formed in a circular arc shape.

The housing 250 may include a second guide groove. The second guide groove may be formed in one surface of the housing 250. In addition, the second holder 221 may include the second guide groove. The second guide groove may be formed in one surface of the second holder 221. The one surface of the housing 250 in which the second guide groove is formed and the one surface of the second holder 221 in which the second guide groove is formed may be facing surfaces. Therefore, when the second holder 221 is accommodated in the housing 250, the second guide groove of the housing 250 may overlap the second guide groove of the second holder 221. A second ball 223 may be disposed between the second guide groove of the housing 250 and the second guide groove of the second holder 221. The second guide groove may be formed in a circular arc shape.

Specifically describing the guide groove with reference to FIG. 22, the first guide groove having a circular arc shape may be formed in the one surface of the first holder 211. Two first guide grooves may be formed. Two first guide grooves 211-1 and 211-2 formed in the one surface of the first holder 211 may be symmetrically disposed. The two first guide grooves 211-1 and 211-2 formed in the one surface of the first holder 211 may be symmetrically disposed with respect to the first rotation axis RX1 or the second rotation axis RX2. In FIG. 22, although the two first guide grooves formed in the one surface of the first holder 211 are illustrated, three or more first guide grooves may be formed.

In addition, the first guide groove having a circular arc shape may be formed in the one surface of the housing 250 to face the one side of the first holder 211 in which the first guide groove is formed. Two first guide grooves formed in the one surface of the housing 250 may also be formed. Two first guide grooves 251-1 and 250-2 formed in the one surface of the housing 250 may be symmetrically disposed. The two first guide grooves 251-1 and 250-2 formed in the one surface of the housing 250 may be symmetrically disposed with respect to the first rotation axis RX1 or the second rotation axis RX2. In FIG. 22, although the two first guide grooves formed in the one surface of the housing 250 are illustrated, three or more first guide grooves may be formed.

The first ball 213 may be disposed between the first guide groove of the first holder 211 and the first guide groove of the housing 250. When the first holder 211 rotates about the first rotation axis RX1 or the second rotation axis RX2 with respect to the housing 250, the first holder 211 may rotate using the first balls 213 disposed between the first guide grooves 211-1 and 251-1, and 211-2 and 250-2 overlapping each other.

Since the first balls 213 are disposed between the first guide grooves 211-1 and 211-2 of the first holder 211 and the first guide grooves 251-1 and 250-2 of the housing 250 overlapping each other, it is possible to prevent the separation of the first balls 213 when the first holder 211 rotates. In addition, as the first guide groove is formed in a circular arc shape, it is possible to improve mechanical efficiency when the first holder 211 rotates. In addition, as the first guide groove is formed in a circular arc shape, it is possible to prevent rotation at a predetermined angle or more, thereby increasing OIS accuracy.

In FIG. 22, although the relationship between the first holder 211 and the housing 250 has been exemplarily illustrated and described, this can also be applied to the relationship between the second holder 221 and the housing in the same manner.

Although embodiments have been mainly described above, these are only illustrative and do not limit the present invention, and those skilled in the art to which the present invention pertains can know that various modifications and applications not exemplified above are possible without departing from the essential characteristics of the embodiments. For example, each component specifically illustrated in the embodiments may be implemented by modification. In addition, differences related to these modifications and applications should be construed as being included in the scope of the present invention defined in the appended claims.

1. A camera module comprising:
a first optical unit configured to change a path of received light from a first direction to a second direction and output the light;
a second optical unit disposed at an image side of the first optical unit and configured to change the path of the light received from the first optical unit from the second direction to a third direction and output the light;
a first lens unit disposed at an image side of the second optical unit and configured to receive the light output from the second optical unit; and
a sensor unit configured to receive light output from the first lens unit and generate an electrical signal,
wherein, in a first optical image stabilizer (OIS) mode in which a path of the light incident on the sensor unit is tilted in a vertical direction with respect to the sensor unit, the first optical unit and the second optical unit rotate about a first rotation axis.

2. The camera module of claim 1, wherein the first rotation axis is an optical axis of the first lens unit.

3. The camera module of claim 1, wherein the first optical unit and the second optical unit rotate in the same direction in the first OIS mode.

4. The camera module of claim 1, wherein, in a second OIS mode in which the path of the light incident on the sensor unit is tilted in a left-right direction with respect to the sensor unit, the first optical unit rotates about a second rotation axis.

5. The camera module of claim 4, wherein the second rotation axis is an optical axis between the first optical unit and the second optical unit.

6. The camera module of claim 1, wherein the first optical unit includes a first incident surface on which light is incident, a first reflective surface by which the light incident through the first incident surface is reflected, and a first emitting surface through which the light reflected by the first reflective surface is output, and
the second optical unit includes a second incident surface on which light is incident, a second reflective surface by which the light incident through the second incident surface is reflected, and a second emitting surface through which the light reflected by the second reflective surface is output.

7. The camera module of claim 6, wherein the first emitting surface is disposed parallel to the second incident surface.

8. The camera module of claim 6, wherein the first incident surface is disposed perpendicular to the second emitting surface.

9. The camera module of claim 6, further comprising a second lens unit disposed at an object side of the first optical unit.

10. The camera module of claim 9, wherein the second lens unit is formed integrally with the first incident surface or mechanically coupled to the first optical unit to move integrally.

11. The camera module of claim 1, further comprising a first holder, and wherein the first optical unit is accommodated in the first holder.

12. The camera module of claim 11, wherein the first holder is coupled to the first optical unit through a barrel, and the first optical unit moves according to a movement of the first holder.

13. The camera module of claim 11, wherein further comprising a first actuator, and wherein the first actuator is coupled to the first holder.

14. The camera module of claim 13, wherein the first actuator provides a driving force so that the first holder rotates about an arbitrary rotation axis.

15. The camera module of claim 4, wherein in the second OIS mode, the second optical unit does not move.

16. The camera module of claim 13, further comprising a second holder and a second actuator.

17. The camera module of claim 16, wherein the second optical unit is accommodated in the second holder, and the second holder is coupled to the second optical unit through a barrel.

18. The camera module of claim 17, wherein the second actuator provides a driving force so that the second holder rotates about an arbitrary rotation axis.

19. The camera module of claim 1, wherein the second lens unit includes at least one lens having a thickness of an edge portion of an effective diameter smaller than a thickness of a central portion of the effective diameter.

20. The camera module of claim 16, further comprising a third holder and a third actuator, and wherein the first lens unit is accommodated in the third holer.
